(19) United States
(12) Patent Application Publication
(10) Pub. No.: US 2026/0160201 A1
(43) Pub. Date: Jun. 11, 2026

(54) IN-VEHICLE INTERNAL COMBUSTION ENGINE

(71) Applicant: TOYOTA JIDOSHA KABUSHIKI KAISHA, Toyota-shi (JP)

(72) Inventors: Yuichi Miyazaki, Susono-shi (JP); Yuya Horii, Toyota-shi (JP)

(73) Assignee: TOYOTA JIDOSHA KABUSHIKI KAISHA, Toyota-shi (JP)

(21) Appl. No.: 19/294,906

(22) Filed: Aug. 8, 2025

(30) Foreign Application Priority Data
Dec. 10, 2024 (JP) 2024-215411

(51) Int. Cl. F02B 75/22; B60K 5/02; F02M 61/14

(52) U.S. Cl. CPC F02B 75/228; B60K 5/02; F02M 61/14

(57) ABSTRACT

An engine is a V-type engine including two banks of a right bank and a left bank. The engine includes a head cover to which a fuel supply device that supplies fuel to a cylinder is fitted in each bank. In the engine, a rotational axis direction of a crankshaft is a front-rear direction of the engine, and a direction parallel to a reference plane that is a horizontal plane in a posture of the engine while the engine is mounted on a vehicle and orthogonal to the front-rear direction is a left-right direction of the engine. The engine is provided with a protrusion on the head cover that is located outward of a delivery pipe that is a portion exposed from the head cover in the fuel supply device, in a left-right direction.

### CROSS-REFERENCE TO RELATED APPLICATION

This application claims priority to Japanese Patent Application No. 2024-215411 filed on Dec. 10, 2024. The disclosure of the above-identified application, including the specification, drawings, and claims, is incorporated by reference herein in its entirety.

### BACKGROUND

### 1. Technical Field

The present disclosure relates to an in-vehicle internal combustion engine.

### 2. Description of Related Art

Japanese Unexamined Patent Application Publication No. 2004-245147 (JP 2004-245147 A) discloses a structure of a protection device that protects a fuel-system component from being damaged at the time when a vehicle collides. The protection device is fixed to a boss portion of an internal combustion engine body with a bolt such that the protection device covers the fuel-system component, such as a fuel tube or a fuel injection valve, disposed in a vicinity of an internal combustion engine. The protection device receives a load acting on the fuel-system component due to the collision of the vehicle to reduce the load acting on the fuel-system component.

### SUMMARY

The protection device is installed to cover the fuel-system component. Therefore, a space that needs to be secured for mounting the internal combustion engine is expanded as the protection device is located to surround the internal combustion engine body.

An in-vehicle internal combustion engine for solving the above problem includes two banks that are a first bank including a plurality of cylinders disposed along a rotational axis direction of a crankshaft and a second bank including a plurality of cylinders disposed along the rotational axis direction of the crankshaft. The in-vehicle internal combustion engine is a V-type in-vehicle internal combustion engine provided with an intake manifold outward of each of the banks. In the in-vehicle internal combustion engine, a head cover to which a fuel supply device supplying fuel to the cylinders is fitted is provided in each of the banks. In the in-vehicle internal combustion engine, the rotational axis direction of the crankshaft is defined as a front-rear direction of the in-vehicle internal combustion engine. In the in-vehicle internal combustion engine, a direction parallel to a reference plane and orthogonal to the front-rear direction is defined as a left-right direction of the in-vehicle internal combustion engine, the reference plane being a horizontal plane in a posture of the in-vehicle internal combustion engine while the in-vehicle internal combustion engine is mounted on a vehicle. In the in-vehicle internal combustion engine, a protrusion is provided on the head cover, the protrusion being located outward of a portion of the fuel supply device that is exposed from the head cover, in the left-right direction.

With the in-vehicle internal combustion engine, it is possible to protect a fuel-system component while an increase in a space needed for mounting the in-vehicle internal combustion engine is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic top view of a vehicle equipped with an engine that is an embodiment of an in-vehicle internal combustion engine;

FIG. 2 is a rear view of the engine of FIG. 1 as viewed from the rear side of the engine;

FIG. 3 is a top view of a right bank of the engine of FIG. 1 as viewed from above the engine;

FIG. 4 is an enlarged view of a portion surrounded by a one-dot chain line in FIG. 2;

FIG. 5 is a top view of the protrusions shown in FIGS. 2 to 4 as viewed from the direction of an arrow 5 shown by a one-dot chain line in FIG. 4; and

FIG. 6 is a top view of the protrusion of Modification as viewed from the same direction as in FIG. 5.

### DETAILED DESCRIPTION OF EMBODIMENTS

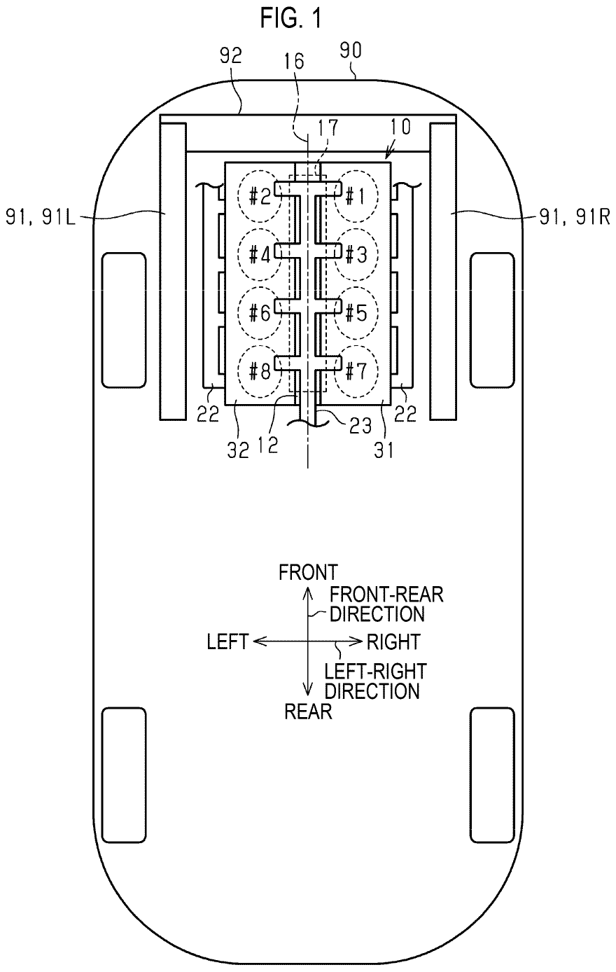

Hereinafter, the engine 10 that is an embodiment of the in-vehicle internal combustion engine will be described with reference to FIGS. 1 to 5.

### Configuration of Vehicle 90

FIG. 1 is a schematic top view of a vehicle 90 equipped with an engine 10 as viewed from an upper surface of the vehicle 90. FIG. 1 shows a front-rear direction and a left-right direction of the vehicle 90 by arrows.

As shown in FIG. 1, the engine 10 is mounted on a front side of a vehicle 90. As shown in FIG. 1, the direction that is orthogonal to the front-rear direction of the vehicle 90 and is horizontal is the left-right direction. A direction toward a right hand side toward ahead of the vehicle 90 is a right direction, and a direction toward a left hand side toward ahead of the vehicle 90 is a left direction.

The engine 10 includes a crankshaft 17 and eight cylinders #1 to #8. In FIG. 1, the crankshaft 17 and eight cylinders #1 to #8 are indicated by broken lines, respectively. A one-dot chain line in FIG. 1 indicates a rotational axis 16 of a crankshaft 17. The engine 10 includes two banks, a right bank 31 and a left bank 32. The engine 10 is a V-type engine. The two banks are provided at an angle that forms a V-shape when viewed from the axial direction of the rotational axis 16. The engine 10 is a vertical V-type engine. That is, the engine 10 is mounted on the vehicle 90 such that the axial direction of the rotational axis 16 of the crankshaft 17 coincides with the front-rear direction of the vehicle 90.

In the engine 10, a direction along the axial direction of the rotational axis 16 of the crankshaft 17 is a front-rear direction. A reference plane is set in the engine 10. The reference plane of the engine 10 is set to coincide with a horizontal plane in the posture of the engine 10 while the engine 10 is mounted on the vehicle. A left-right direction of the engine 10 is a direction parallel to the reference plane and orthogonal to the front-rear direction of the engine 10.

As shown in FIG. 1, in the vehicle 90, a front-rear direction of the vehicle 90 and a front-rear direction of the engine 10 coincide with each other. As shown in FIG. 1, in the vehicle 90, the left-right direction of the vehicle 90 and the left-right direction of the engine 10 coincide with each other.

In the right bank 31, four cylinders #1, #3, #5, #7 are disposed along the axial direction of the rotational axis 16 of the crankshaft 17. In the left bank 32, four cylinders #2, #4, #6, #8 are disposed along the axial direction of the rotational axis 16 of the crankshaft 17. The right bank 31 is a first bank in the engine 10. The left bank 32 is a second bank in the engine 10.

The engine 10 includes two intake manifolds 22 and one exhaust manifold 23. The engine 10 is a so-called V-type engine with an outer bank intake. An intake manifold 22 is attached to an outside of each of the right bank 31 and the left bank 32 of the engine 10. The right bank 31 and the left bank 32 are introduced with the intake air from the outside through the intake manifolds 22 connected to the respective banks.

The exhaust manifold 23 is fitted to the inside of the right bank 31 and the left bank 32 of the engine 10. The exhaust gas from the right bank 31 and the left bank 32 is discharged to the outside through the exhaust manifold 23 connected to both banks.

As shown in FIG. 1, the vehicle 90 includes a cross member 92 that is a skeleton component of the vehicle 90, and two side members 91, that is, a right side member 91R and a left side member 91L.

The cross member 92 is disposed in front of the engine 10. The cross member 92 extends long in the left-right direction of the vehicle 90.

The right side member 91R is disposed to the right of the engine 10. The left side member 91L is disposed to the left of the engine 10. Both of the two side members 91 extend long in a front-rear direction of the vehicle 90. A front end of the right side member 91R is connected to a right end portion of the cross member 92. A front end of the left side member 91L is connected to a left end portion of the cross member 92.

The engine 10 is surrounded by three directions of a front direction, a left direction, and a right direction by the cross member 92 and the two side members 91.

### Configuration of Engine 10

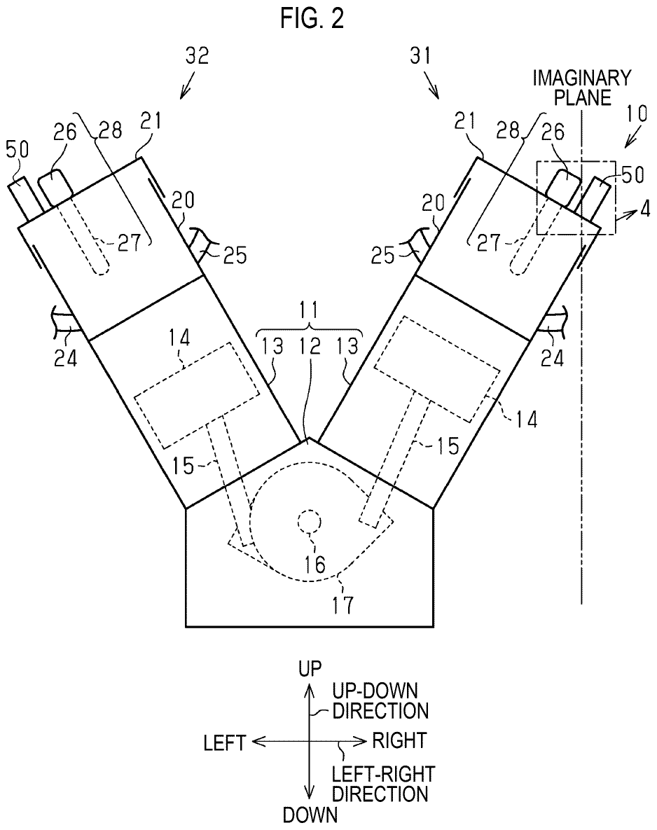

FIG. 2 is a rear view of the engine 10 as viewed from a rear side of the engine 10.

As shown in FIG. 2, the engine 10 includes a cylinder block 11, two cylinder heads 20, and two head covers 21. The cylinder block 11 includes a crankcase 12 and two cylinder rows 13 above the crankcase 12. The up-down direction of the engine 10 is a direction orthogonal to both the front-rear direction of the engine 10 and the left-right direction of the engine 10.

In the right cylinder row 13 in FIG. 2, four cylinders #1, #3, #5, #7 are lined up. In the left cylinder row 13 in FIG. 2, four cylinders #2, #4, #6, #8 are lined up. Each cylinder constitutes a lower portion of a combustion chamber that combusts an air-fuel mixture of fuel and intake air. The fuel in the engine 10 is, for example, gasoline.

A cylinder head 20 is attached to an upper portion of each cylinder row 13. By combining the cylinder row 13 and the cylinder head 20 as one set, four combustion chambers are provided per bank.

A head cover 21 is attached to an upper portion of each cylinder head 20. Each of the right bank 31 and the left bank 32 includes a cylinder row 13, a cylinder head 20, and a head cover 21.

As shown in FIG. 2, a piston 14 and a connecting rod 15 are housed in the interior of each cylinder in the cylinder row 13. The connecting rod 15 is connected to a crankshaft 17 housed in the crankcase 12.

Each cylinder head 20 is provided with an intake passage 24 and an exhaust passage 25. Each cylinder head 20 is provided with an ignition device, an intake valve, and an exhaust valve that are not shown.

The intake passage 24 is an end portion in which each intake manifold 22 shown in FIG. 1 branches toward the four combustion chambers in each cylinder row 13. The above-described end portion of the intake passage 24 is connected to the cylinder head 20. The intake passage 24 introduces the intake air flowing from the outside through the intake manifold 22 into each combustion chamber of each cylinder row 13. The above-described end portion of the intake passage 24 communicates with the combustion chamber. An opening of the intake passage 24 to the combustion chamber is opened and closed by an intake valve.

The exhaust passage 25 is an end portion in which the exhaust manifold 23 shown in FIG. 1 branches toward the four combustion chambers in each of the cylinder rows 13. The above-described end portion of the exhaust passage 25 is connected to the cylinder head 20. The exhaust passage 25 introduces exhaust gas from each combustion chamber of each cylinder row 13 to the exhaust manifold 23. The above-described end portion of the exhaust passage 25 communicates with the combustion chamber. An opening of the exhaust passage 25 to the combustion chamber is opened and closed by an exhaust valve.

### Configuration of Fuel Supply Device 28

As shown in FIG. 2, a fuel supply device 28 is fitted to each head cover 21. The fuel supply device 28 is configured by the injector 27 and the delivery pipe 26. The delivery pipe 26 stores the fuel supplied from the fuel tank. The delivery pipe 26 is a passage that supplies the high-pressure fuel stored inside to the injector 27. The injector 27 directly injects high-pressure fuel in the delivery pipe 26 into the combustion chamber to supply the fuel.

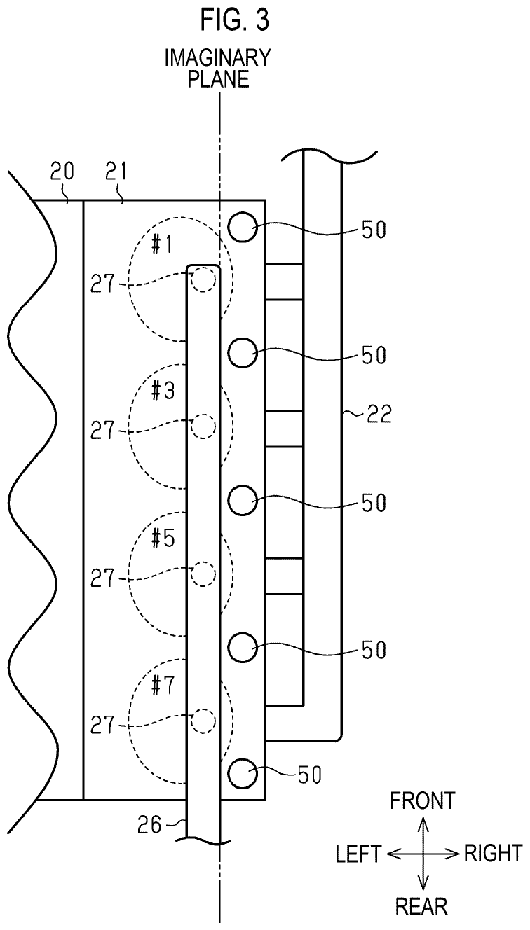

FIG. 3 is a top view of the right bank 31 as viewed from above the engine 10. As shown in FIG. 3, four injectors 27 that inject fuel into combustion chambers in each of the cylinders #1, #3, #5, #7 are fitted to the head cover 21 in the right bank 31. The delivery pipe 26 is attached to the head cover 21 such that the delivery pipe 26 extends from the rear end of the engine 10 to the front side of the engine 10. The delivery pipe 26 supplies fuel to four injectors 27.

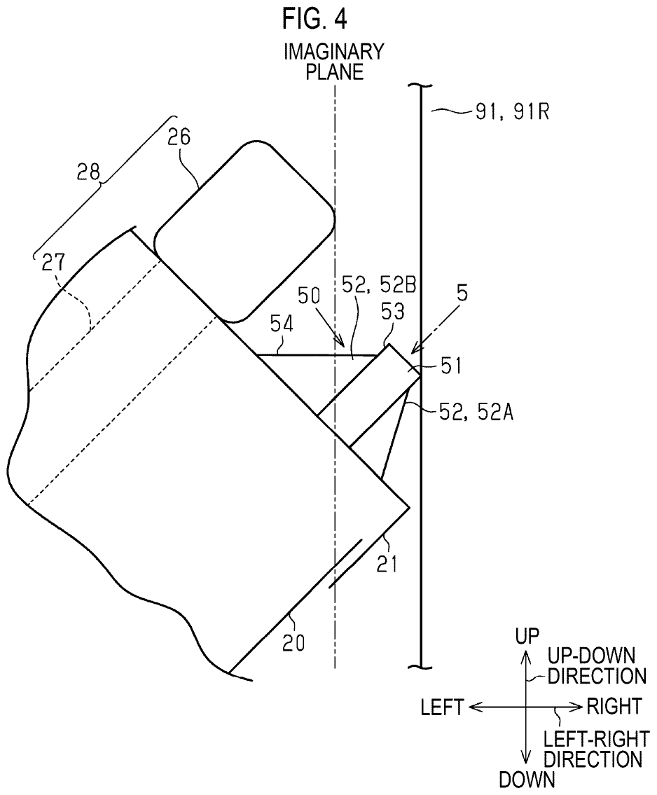

FIG. 4 is an enlarged view of a portion surrounded by a one-dot chain line in FIG. 2. As shown in FIG. 4, the injector 27 is disposed from the head cover 21 into the inside of the cylinder head 20. The injector 27 is fixed to the head cover 21.

The delivery pipe 26 protrudes upward from the head cover 21. More specifically, the delivery pipe 26 protrudes outward of the engine 10 in the left-right direction and protrudes above the engine 10 in the up-down direction. In the fuel supply device 28, a delivery pipe 26 that is a part of the fuel supply device 28 is exposed from the head cover 21.

### Configuration of Protrusion 50

As shown in FIG. 4, the head cover 21 is provided with a protrusion 50. The protrusion 50 is provided on the right side of the position of the delivery pipe 26.

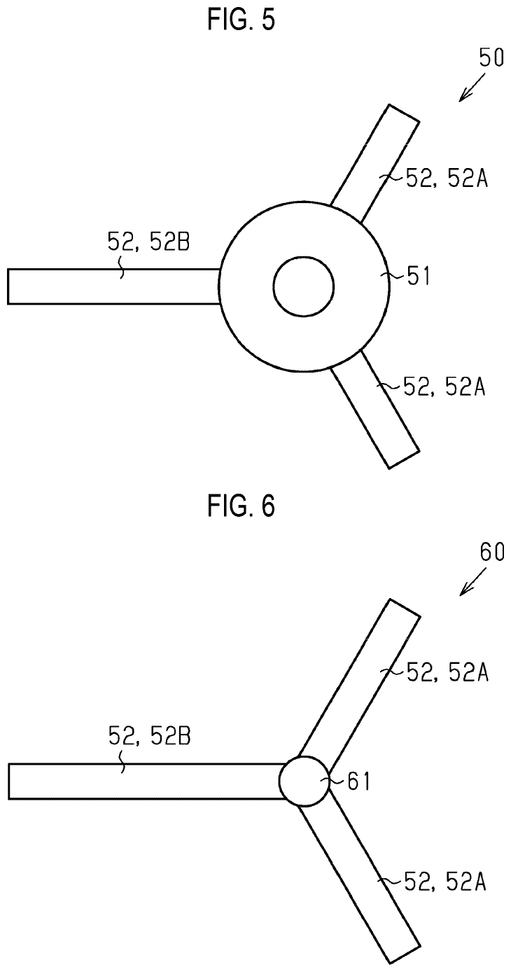

FIG. 5 is a top view of the protrusion 50 viewed from the direction of the arrow 5 shown by the one-dot chain line in FIG. 4.

As shown in FIGS. 4 and 5, the protrusion 50 includes a boss 51 and three ribs 52. That is, the protrusion 50 is a ribbed boss including the rib 52 on the boss 51. The boss 51 has a cylindrical shape.

The rib 52 extends from the side surface of the boss 51 toward outward of the boss 51 in a radial direction. An end of the rib 52 is located on the head cover 21. The three ribs 52 are disposed at positions where the center angle formed by the ribs 52 with respect to each other is 120 degrees, with the boss 51 as a center.

As shown in FIG. 4, each rib 52 is provided on the side surface of the boss 51 from the root of the boss 51 to a position in front of the tip of the boss 51. The boss 51 is provided to be inclined to the right side in FIG. 4 with respect to the up-down direction of the engine 10. The upper portion of the boss 51 provided to be inclined in this way is located further to the right in FIG. 4.

Further, as shown in FIG. 4, a portion of the protrusion 50 that is located most rightward is a tip of the boss 51.

As shown in FIGS. 4 and 5, the three ribs 52 of the protrusion 50 are constituted by an upper rib 52B and two side ribs 52A. As shown in FIG. 4, two ribs 52 extending toward below the engine 10 from the side surface of the boss 51 are side ribs 52A.

On the other hand, a rib 52 extending to the left side of the engine 10 in the left-right direction from the side surface of the boss 51 is an upper rib 52B. The upper rib 52B is provided on a boss upper surface 53 that is a part of the side surface of the boss 51. The boss upper surface 53 is a portion on the side surface of the side surfaces of the boss 51 that is located on an uppermost side of the engine 10 in the up-down direction.

As shown in FIG. 4, the rib upper surface 54 is a surface on the upper side of the upper rib 52B. The rib upper surface 54 is parallel to the reference plane of the engine 10. That is, the upper rib 52B extends along the reference plane to the end of the upper rib 52B connected from the boss upper surface 53 to the head cover 21.

### Position Relationship between Delivery Pipe 26 and Protrusion 50

As shown in FIG. 4, the protrusion 50 is provided on the right side of the delivery pipe 26 exposed from the head cover 21, in the head cover 21. The imaginary plane shown by the two-dot chain line in FIG. 4 is an imaginary plane orthogonal to the left-right direction of the engine 10, passing through the rightmost position in the delivery pipe 26. As shown in FIG. 4, a part of the protrusion 50 protrudes to the right of the imaginary plane. That is, the protrusion 50 is located on the right side of the delivery pipe 26 in FIG. 4.

The description of the protrusion 50 above is also established even when the right bank 31 is replaced with the left bank 32. In this case, the left and right expressions in the above description are appropriately reinterpreted to exchange the left and right. For example, the protrusion 50 provided in the head cover 21 of the left bank 32 is located on the left side of the delivery pipe 26 outward of the engine 10 in the left-right direction.

### Operation of Present Embodiment

When a collision of the vehicle 90 occurs, the side member 91 that is a component disposed around the engine 10 may be pushed toward the engine 10. In a case where the side member 91 is pushed toward the engine 10 due to the collision, the side member 91 may come into contact with the delivery pipe 26 that is a portion exposed from the head cover 21 in the fuel supply device 28.

As shown in FIG. 4, the engine 10 includes a protrusion 50 outward of the delivery pipe 26 in the left-right direction of the engine 10. Therefore, when the side member 91 disposed around the engine 10 is pushed toward the engine 10 due to the collision, the side member 91 first contacts the protrusion 50 before contacting the delivery pipe 26. As a result, the protrusion 50 can suppress the contact between the delivery pipe 26 and the side member 91. In addition, the protrusion 50 does not cover the entire delivery pipe 26. Therefore, the protrusion 50 can realize the above-described function with a relatively small structure.

### Effect of Present Embodiment

(1) With the engine 10, the delivery pipe 26 can be protected while the increase in space needed for mounting is suppressed.
(2) The protrusion 50 of the engine 10 is a ribbed boss that includes a rib 52 that extends outward of the boss 51 in the radial direction on the side surface of the boss 51 having a cylindrical shape. In the engine 10, the tip of the boss 51 of the protrusion 50 is located most outward of the engine 10 in the left-right direction.

By providing the rib 52 on the side surface of the boss 51, the rigidity of the boss 51 can be improved. The engine 10 includes a ribbed boss that is increased in rigidity by the rib 52 as the protrusion 50.

With the engine 10, even in a case where a strong impact is applied to the vehicle 90 due to the collision, the damage to the delivery pipe 26 can be suppressed.
(3) Each rib 52 of the protrusion 50 of the engine 10 is disposed at equal angles with the boss 51 as the center.

By disposing three or more ribs 52 at equal angles, the protrusion 50 has high rigidity regardless of the direction of the load input by the collision. With the engine 10, the protrusion 50 that exhibits high rigidity regardless of the input direction of the load can be realized, and the damage of the delivery pipe 26 can be suppressed.
(4) The engine 10 includes three ribs 52 provided in the protrusion 50.
In a case where the plurality of ribs 52 is disposed at equal angles, the minimum number of the ribs 52 that the protrusion 50 can exhibit high rigidity with respect to the load input from any direction is three. The protrusion 50 of the engine 10 has high rigidity with the minimum number of ribs 52 in any direction of the load. The protrusion 50 can be reduced in size by reducing the number of ribs 52.

With the engine 10, an increase in weight due to the provision of the protrusion 50 can be suppressed.
(5) The engine 10 is inclined such that the upper portion of the boss 51 in the up-down direction of the engine 10 that is orthogonal to both the front-rear direction of the engine 10 and the left-right direction of the engine 10 is located outward in the left-right direction. In the engine 10, an upper rib 52B provided on the boss upper surface 53 that is the upper surface of the side surfaces of the boss 51 in the posture of the engine 10 while the engine 10 is mounted on the vehicle extends from the boss upper surface 53 to the end of the upper rib 52B along the reference plane.

In the engine 10, the upper rib 52B provided on the boss upper surface 53 of the side surfaces of the boss 51 is disposed to fill a gap located above the boss 51 in the posture of the engine 10 while the engine 10 is mounted on the vehicle and to be pulled in the horizontal direction. With the engine 10, the rigidity of the protrusion 50 with respect to the deformation of the boss 51 such that the boss 51 is inclined inward of the engine 10 in the left-right direction by the load acting on the protrusion 50 inward in the left-right direction can be increased.

With the engine 10, the delivery pipe 26 located inward of the protrusion 50 in the left-right direction of the engine 10 can be more effectively protected.

### Modification

The present embodiment described above can be modified and carried out as follows. The present embodiment described above and the following Modifications can be carried out in combination within a technically consistent range.

The shape of the boss 51 is not limited to a cylindrical shape. The shape of the boss 51 may be substantially cylindrical. The shape of the boss 51 may be, for example, a substantially columnar shape, a substantial frustum shape, and a substantial prism shape. The rib 52 may be provided to be connected to another boss provided in the engine 10. For example, the rib 52 may be a rib 52 that connects the boss 51 to another boss adjacent to the boss 51.

The number of ribs 52 that the protrusion 50 includes may not be three. The number of ribs 52 that the protrusion 50 includes may be three or more. The number of the ribs 52 provided in the protrusion 50 is not limited to three or more. The number of ribs 52 provided in the protrusion 50 may be one or two. The protrusion 50 may have a configuration in which solely the boss 51 is provided without the rib 52.

In a case where three or more ribs 52 are provided, the ribs 52 may be disposed such that the respective ribs 52 are disposed at equal angles with respect to each other by changing the magnitude of the center angle formed by the respective ribs 52 in accordance with the number of the ribs 52 that the protrusion 50 includes. By disposing three or more ribs 52 at equal angles with the boss 51 as the center, the effect of (3) described above is obtained.

The respective ribs 52 of the protrusion 50 may not be disposed at equal angles with the boss 51 as the center. The ribs 52 may be disposed to be biased in a position where the rigidity with respect to the load is easily increased in consideration of the direction of the load that is likely to be generated by the collision of the vehicle 90.

The rib 52 may be provided from the root of the boss 51 to the tip of the boss 51. The protrusion 50 is a ribbed boss including a rib 52 on the boss 51. The protrusion 50 may not be a ribbed boss. For example, the protrusion 50 may have a shape in which the rib 52 portion in the protrusion 50 is solely combined without the boss 51.

As an example, FIG. 6 shows the protrusion 60 to which Modification described above is applied. FIG. 6 is a top view of the protrusion 60 viewed from the same direction as in FIG. 5, as in FIG. 5. The protrusion 60 includes three ribs 52, that is, an upper rib 52B and two side ribs 52A, in the same manner as the protrusion 50. The protrusion 60 has a shape in which the three ribs 52 extend radially from the center portion 61 of the protrusion 60.

The center portion 61 is smaller than the boss 51. The protrusion 60 can be made lighter in weight by reducing the size of the center portion 61 of the protrusion 60 than the boss 51.

With the protrusion 60, the effects of (1) to (5) can be achieved while an increase in weight of the protrusion portion is suppressed.

The engine 10 may not be a vertical V-type engine. The engine 10 may be a V-type engine laid down in which the axial direction of the rotational axis 16 of the crankshaft 17 coincides with the left-right direction of the vehicle 90. In this case, when the cross member 92 disposed in front of the engine 10 is pushed toward the engine 10 due to the collision of the vehicle 90, the cross member 92 contacts the protrusion 50 before the cross member 92 contacts the delivery pipe 26. With the protrusion 50, the effect of (1) can be achieved when the vehicle 90 collides from the front.

The engine 10 is not limited to a V-type engine. The engine 10 may be, for example, an in-line engine or a horizontally opposed engine. The present disclosure can be applied in a case where a component of the fuel system that is exposed from the head cover 21 is disposed at a position where the component contacts a component disposed around the engine 10 at the time when the vehicle 90 collides in the posture of the engine 10 while the engine 10 is mounted on the vehicle. For example, in a case where the horizontally opposed engine is mounted in a vertical direction, the fuel-system component protrudes outward from a head cover in the horizontally opposed engine in a left-right direction. In this case, the effect of (1) can be obtained by providing the protrusion 50 to extend outward of the exposure portion of the fuel-system component in the left-right direction.

What is claimed is:

1. A V-type in-vehicle internal combustion engine comprising two banks that are a first bank including a plurality of cylinders disposed along a rotational axis direction of a crankshaft and a second bank including a plurality of cylinders disposed along the rotational axis direction of the crankshaft, the in-vehicle internal combustion engine being provided with an intake manifold outward of each of the banks, wherein:
a head cover to which a fuel supply device supplying fuel to the cylinders is fitted is provided in each of the banks; and
when the rotational axis direction of the crankshaft is defined as a front-rear direction of the in-vehicle internal combustion engine, and a direction parallel to a reference plane and orthogonal to the front-rear direction is defined as a left-right direction of the in-vehicle internal combustion engine, the reference plane being a horizontal plane in a posture of the in-vehicle internal combustion engine while the in-vehicle internal combustion engine is mounted on a vehicle, a protrusion is provided on the head cover, the protrusion being located outward of a portion of the fuel supply device that is exposed from the head cover, in the left-right direction.

2. The in-vehicle internal combustion engine according to claim 1, wherein:
the protrusion is a ribbed boss including, on a side surface of a boss having a cylindrical shape, a rib extending outward of the boss in a radial direction; and
a tip of the boss of the protrusion is located most outward in the left-right direction.

3. The in-vehicle internal combustion engine according to claim 2, wherein the ribbed boss includes the three or more ribs, and the ribs are disposed at equal angles with the boss as a center.

4. The in-vehicle internal combustion engine according to claim 3, wherein the number of the ribs provided in the ribbed boss is three.

5. The in-vehicle internal combustion engine according to claim 3, wherein:
the boss is inclined such that an upper portion of the boss in an up-down direction orthogonal to both the front-rear direction and the left-right direction is located further outward in the left-right direction; and
the rib extends along the reference plane from an upper surface of the side surface of the boss to an end of the rib, the rib being provided on the upper surface in the posture of the in-vehicle internal combustion engine while the in-vehicle internal combustion engine is mounted on the vehicle.
